(19) United States
(12) Patent Application Publication
(10) Pub. No.: US 2015/0206182 A1
(43) Pub. Date: Jul. 23, 2015

(54) ADVERTISEMENT SUPPORT APPARATUS, ADVERTISEMENT SUPPORT SYSTEM AND ADVERTISEMENT SUPPORT METHOD

(71) Applicant: TOSHIBA TEC KABUSHIKI KAISHA, Tokyo (JP)

(72) Inventor: Kazunori Kato, Shizuoka-ken (JP)

(73) Assignee: TOSHIBA TEC KABUSHIKI KAISHA, Tokyo (JP)

(21) Appl. No.: 14/157,667

(22) Filed: Jan. 17, 2014

(51) Int. Cl. G06Q 30/02

(52) U.S. Cl. CPC G06Q 30/0253; G06Q 30/0268

(57) ABSTRACT

In accordance with one embodiment, an advertisement support apparatus comprises a purchase associated information acquirement section, a writing apparatus and a writing control section. The purchase associated information acquirement section is configured to acquire information relating to a purchaser of a commodity or the commodity purchased by the purchaser. The writing apparatus is configured to write desired information in a RF tag attached to a shopping basket or a shopping card utilized by the purchaser when the commodity is purchased. The writing control section is configured to write information relating to the information acquired by the purchase associated information acquirement section or advertisement information associated with the information in the RF tag attached to the shopping basket or the shopping card utilized by the purchaser when the commodity is purchased through the writing apparatus.

### FIELD

Embodiments described herein relate to an advertisement provision technology for a purchaser of a commodity.

### BACKGROUND

Conventionally, in a store such as a supermarket or a convenience store and the like, a so-called POS terminal such as a register and the like is utilized, and a content of an advertisement which is displayed on a screen of the POS terminal mentioned above and the like is changed based on the age and the gender of a commodity purchaser or a time period and the like.

However, in a conventional advertisement display method mentioned above, advertisement content is selected based on extremely limited information such as the age, the gender and the like of the commodity purchaser, and whether or not the advertisement with the most suitable content can be provided is not quite clear.

In addition, in a store like the supermarket, in which checkout processing in the register is miscellaneous, if all processes from a checkout procedure in the register to the bagging of a purchased commodity are considered, the time when the purchaser stays in front of the register is relatively short.

### BRIEF DESCRIPTION OF THE DRAWINGS

FIG. 1 is a diagram illustrating schematic constitutions of an advertisement support system according to the present embodiment;

FIG. 2 is a block diagram of the advertisement support system according to the present embodiment;

FIG. 3 is a functional block diagram in the advertisement support system according to the present embodiment;

FIG. 4 is a flowchart illustrating a flow of processing in the advertisement support system;

FIG. 5 is a table illustrating an example of information written in a RF tag 9r by a writing control section 702;

FIG. 6 is a diagram illustrating an example of a corresponding table stored in a database server 3;

FIG. 7 is a diagram illustrating processing when a purchaser utilizes a plurality of shopping baskets 9; and

FIG. 8 is a diagram illustrating another example of a data table stored in the database server 3.

### DETAILED DESCRIPTION

In accordance with one embodiment, an advertisement support apparatus comprises a purchase associated information acquirement section, a writing apparatus and a writing control section. The purchase associated information acquirement section is configured to acquire information relating to a purchaser of a commodity or the commodity purchased by the purchaser. The writing apparatus is configured to write desired information in a RF tag attached to a shopping basket or a shopping card utilized by the purchaser when the commodity is purchased. The writing control section is configured to write information relating to the information acquired by the purchase associated information acquirement section or advertisement information associated with the information in the RF tag attached to the shopping basket or the shopping card utilized by the purchaser when the commodity is purchased through the writing apparatus.

Hereinafter, embodiments will be described with reference to accompanying drawings.

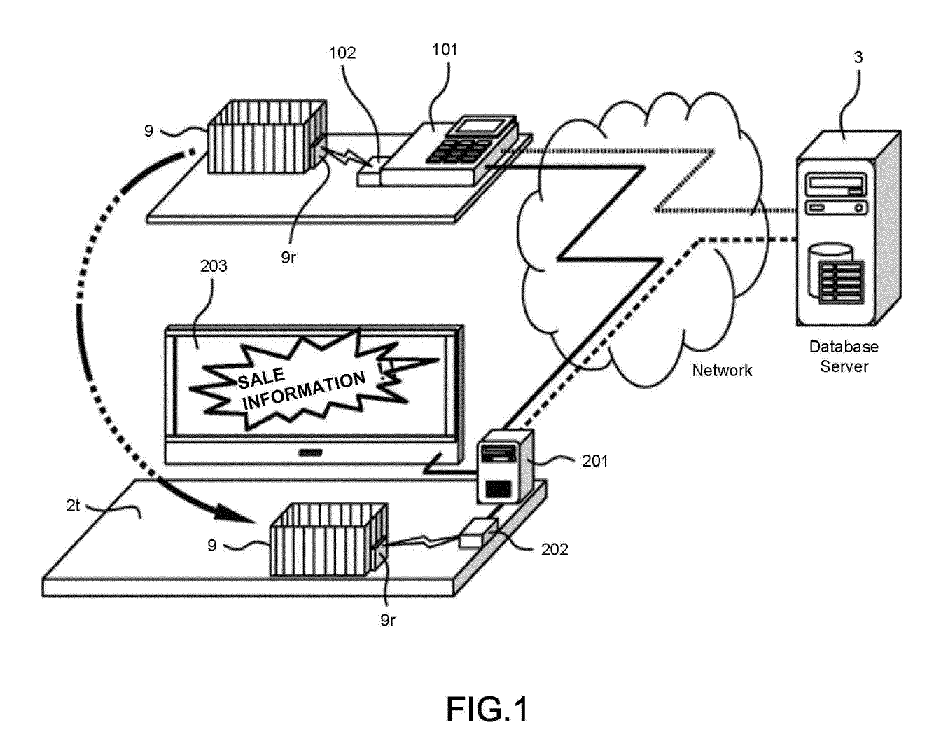

FIG. 1 is a diagram illustrating schematic constitutions of an advertisement support system according to the present embodiment.

As shown in FIG. 1, the advertisement support system according to the present embodiment comprises a register 101 serving as a POS terminal; a writing apparatus 102 connected with the register 101 via a wired or wireless network; an advertisement display terminal 201; a reading apparatus 202 connected with the advertisement display terminal 201 via a wired or wireless network; a display apparatus 203 (a notification apparatus) which is provided with a built-in speaker and connected with the advertisement display terminal 201 via a wired or wireless network; and a database server 3.

All apparatuses constituting the advertisement support system according to the present embodiment are connected to be capable of communicating with each other via an electric communication line such as an internet, a LAN, a WAN and the like. In addition, an electric communication line for connecting these apparatuses to be capable of communicating with each other can be wired or wireless.

Specifically, the writing apparatus 102 can include a RF tag reader-writer and the like, and moreover, is arranged near a position through which a shopping basket passes during checkout processing in the register 101. The writing apparatus 102 writes the desired information in a RF tag 9r attached to a shopping basket 9 utilized by a purchaser when a commodity is purchased.

Further, in the present embodiment, in order to describe conveniently, a case is described as an example where the RF tag 9r is attached to the shopping basket 9, but it is not limited to this, for example, the RF tag may also be attached to an object like a “shopping card” which passes nearby the register 101 during the checkout as the shopping basket does, and further, is also conveyed to a bagging place 2t (herein, as an example, a table arranged at a place for bagging the commodity is shown) when a purchased commodity is bagged.

In addition, the display apparatus 203 (the notification apparatus) is arranged at a position which can be recognized by the purchaser at a taking-out place 2t used when the purchaser takes out the purchased commodity from the shopping basket.

Herein, as an example, a case is exemplified where the notification apparatus is the display apparatus, but in a case where the advertisement information is provided for the purchaser through a sound only, no specific limitation is given to the notification apparatus as long as the notification apparatus comprises a speaker, and the speaker is fine as long as it's arranged at a place where the speaker can be heard by the purchaser.

The reading apparatus 202 can include the RF tag reader-writer and the like, moreover, is arranged near the taking-out place 2t, and reads the information stored in the RF tag 9r attached to the shopping basket 9. Herein, as an example, the reading apparatus 202 is arranged on the table serving as the taking-out place 2t, but it is not limited to this. Namely, no specific limitation is given to the arrangement place of the reading apparatus 202 as long as it is a place at which the information in the RF tag 9r attached to the shopping basket 9 can be eventually read when the purchaser moves towards the taking-out place 2t.

The database server 3 stores various kinds of information which is supposed to be written in the RF tag 9r attached to the shopping basket 9 in association with information for recognizing an advertisement content associated with the information or the advertisement content associated with the information.

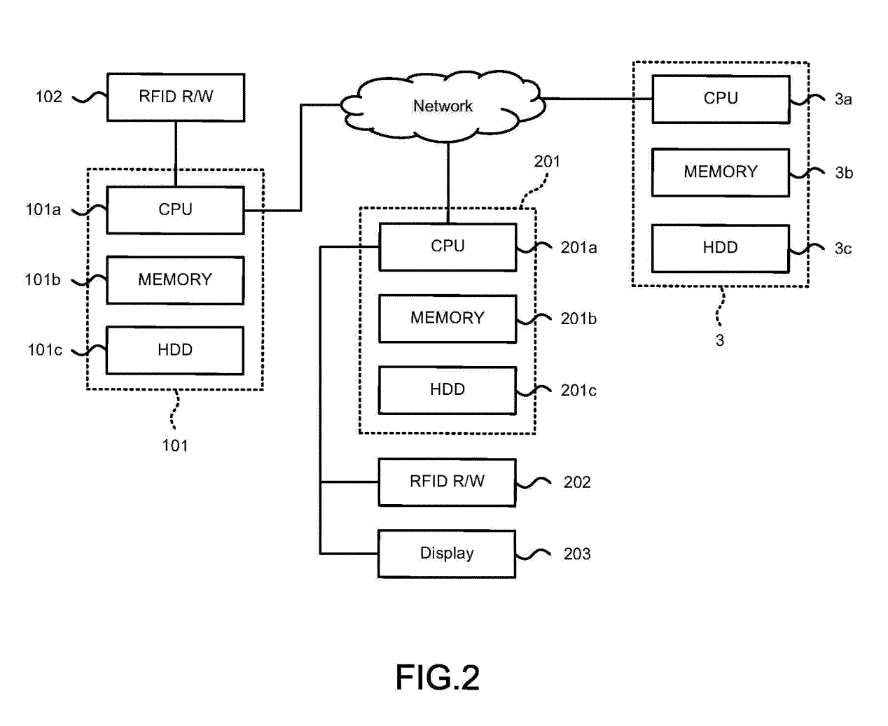

FIG. 2 is a block diagram of the advertisement support system according to the present embodiment.

As shown in FIG. 2, the register 101 comprises a CPU (Central Processing Unit) 101a, a memory 101b and an HDD (Hard Disk Drive) 101c. The CPU 101a mainly carries out various kinds of processing in the register 101. The CPU 101a can also realize various functions by, for example, executing programs stored in the HDD 101c or the memory 101b.

The advertisement display terminal 201 comprises a CPU 201a, a memory 201b and an HDD 201c. The CPU 201a mainly carries out various kinds of processing in the advertisement display terminal 201. The CPU 201a can also realize various functions by, for example, executing programs stored in the HDD 201c or the memory 201b.

The database server 3 comprises a CPU 3a, a memory 3b and an HDD 3c. The CPU 3a mainly carries out various kinds of processing in the database server 3. The CPU 3a can also realize various functions by, for example, executing programs stored in the HDD 3c or the memory 3b.

Furthermore, the CPU 101a, the CPU 201a and the CPU 3a can be also replaced respectively by other processors such as a MPU (Micro Processing Unit) and the like which can execute the same arithmetic processing. In addition, the HDD 101c, the HDD 201c and the HDD 3c, similarly, can be also replaced by storage apparatuses in other storage manners such as a flash memory and the like.

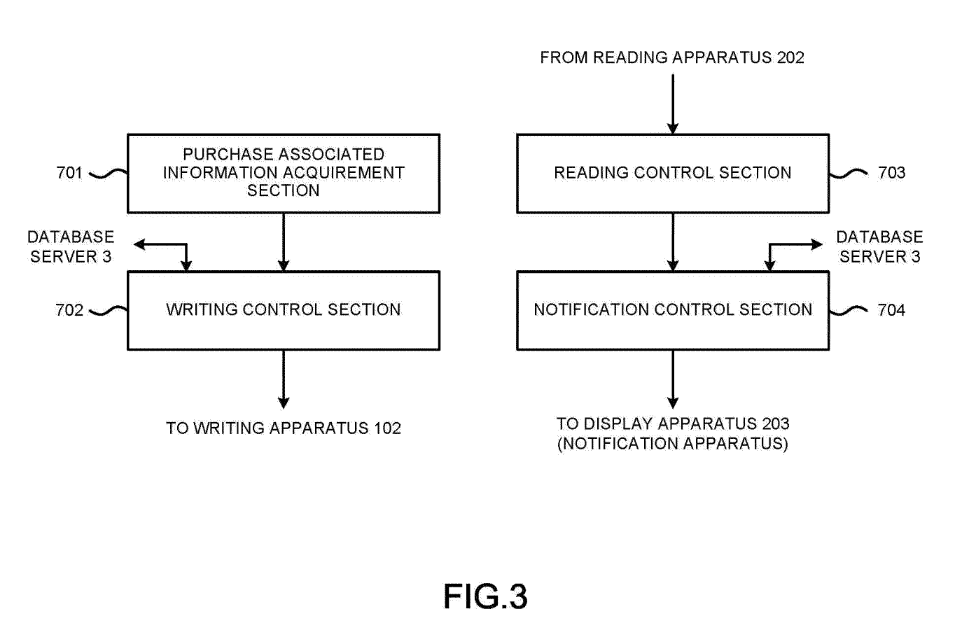

FIG. 3 is a functional block diagram in the advertisement support system according to the present embodiment.

The register 101, for example, has functions as a purchase associated information acquirement section 701 and a writing control section 702.

The purchase associated information acquirement section 701 acquires the information relating to the purchaser of the commodity or the commodity purchased by the purchaser based on data of a checkout result in the register 101. The “information relating to the purchaser of the commodity” herein refers to, for example, a customer name, a customer ID and the like acquired according to the prompt from a membership card, a credit card, a point card and the like during checkout processing. In addition, as the “information relating to the commodity purchased by the purchaser”, recognition information of the commodity purchased by a customer, which is acquired by a barcode reader (not shown) and the like of the register 101 during the checkout processing, and various kinds of information such as names of commodities, and genre names, attributions and the like associated with these commodities can be listed.

The writing control section 702 writes the information acquired by the purchase associated information acquirement section 701 or the information relating to the advertisement information associated with the information in the RF tag 9r attached to the shopping basket 9 utilized by the purchaser when the commodity is purchased through the writing apparatus 102.

In addition, the writing control section 702 writes the information in the RF tag 9r attached to the shopping basket 9 utilized by the purchaser when the commodity is purchased through the writing apparatus 102 after the purchaser completes the checkout.

A reading control section 703 reads the information from the RF tag 9r attached to the shopping basket 9 reaching the taking-out place 2t through the reading apparatus 202 when the shopping basket 9 reaches the taking-out place 2t.

A notification control section 704 notifies the advertisement information determined based on the information stored in the database server 3 in association with the information read by the reading apparatus 202 to the purchaser near the taking-out place 2t through the display apparatus (the notification apparatus) 203.

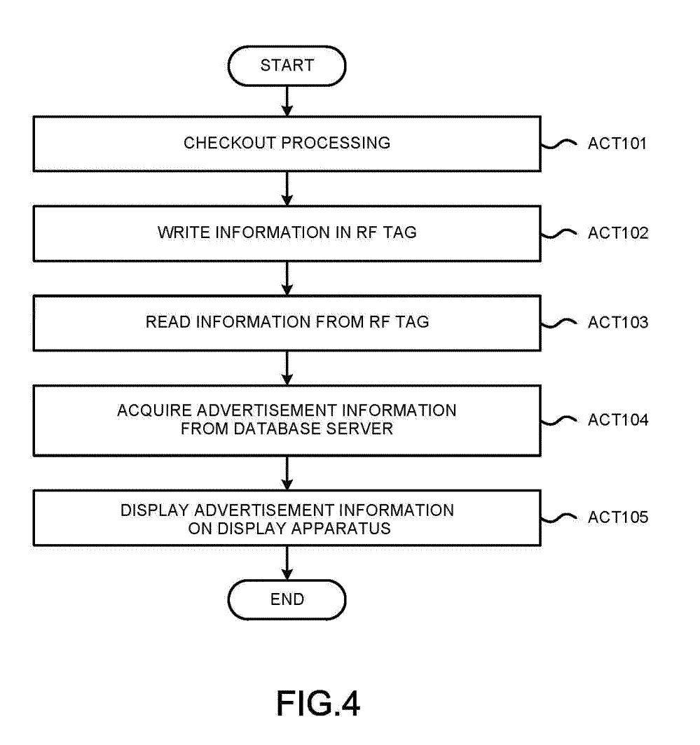

FIG. 4 is a flowchart illustrating a flow of processing in the advertisement support system.

The CPU 101a (the purchase associated information acquirement section 701) acquires the information relating to the purchaser of the commodity or the commodity purchased by the purchaser (ACT 101).

The CPU 101a (the writing control section 702) writes the acquired information or the information relating to the advertisement information associated with the information in the RF tag attached to the shopping basket utilized by the purchaser when the commodity is purchased through the writing apparatus 102 after the purchaser completes the checkout (ACT 102).

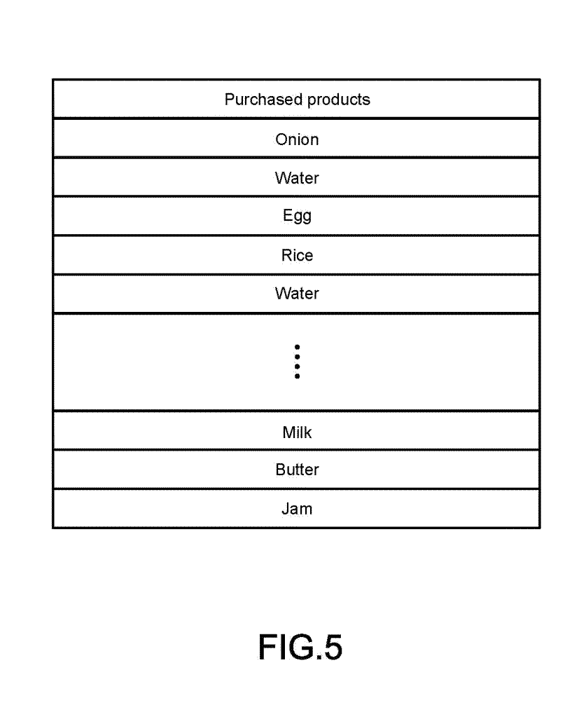

FIG. 5 is a table illustrating an example of information written in the RF tag 9r by the writing control section 702. Herein, commodity names of the commodities purchased by the purchaser are listed in the RF tag 9r. Of course, when the information representing these commodities is written in the RF tag 9r, the commodity names of these commodities are not merely directly written in, for example, ID numbers and the like which are respectively associated with these commodities in advance can be also pre-stored in the HDD 101c and the like, and the corresponding ID numbers (the information relating to the purchased commodity) may also be written in the RF tag 9r. Herein, as an example, the purchaser purchases “Water”, and the word “Water” is also written in the RF tag 9r.

The CPU 201a (the reading control section 703) reads the information from the RF tag attached to the shopping basket reaching the taking-out place through the reading apparatus 202 when the shopping basket reaches the taking-out place for taking out the purchased commodity from the shopping basket (ACT 103). Herein, the information read from the RF tag 9r by the reading apparatus 202 is “Water”.

The CPU 201a (the notification control section 704) accesses the database, display the advertisement information determined based on the information stored in the database server 3 in association with the information read from the RF tag 9r by the reading apparatus 202 on a screen of the display apparatus 203, and notifies the advertisement content to the purchaser at the taking-out place (ACT 104).

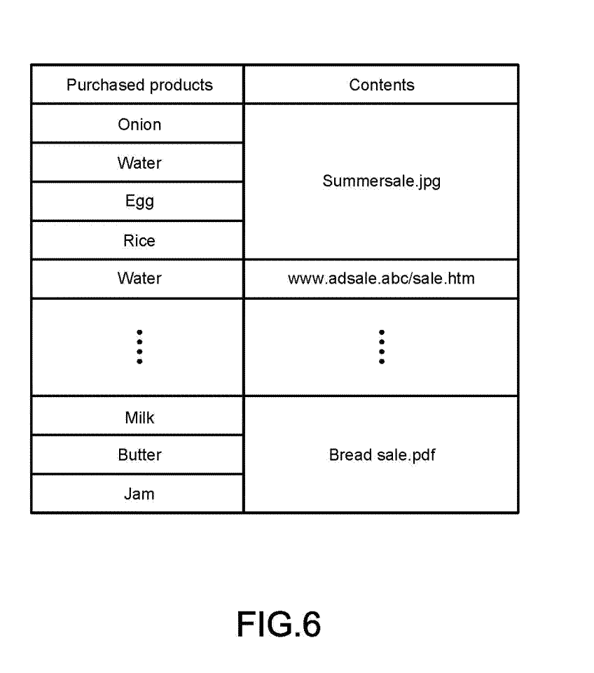

FIG. 6 is a diagram illustrating an example of a corresponding table stored in the database server 3.

Various kinds of information such as the commodity name, a commodity ID and the like written in the RF tag 9r attached to the shopping basket 9 are stored in association with the information (for example, a link to the advertisement information or an ID and the like representing the advertisement information) for recognizing the advertisement content associated with the information or the advertisement content (for example, a PDF and the like of a leaflet for the advertisement, and the advertisement information per se) associated with the information.

Herein, the information read from the RF tag 9r is “Water”, and therefore, data at a location representing a link [www.adsale.abc/sale.htm] from the data table shown in FIG. 6 are displayed as the advertisement information on the screen of the display apparatus 203. Of course, the advertisement information serving as an advertisement target is not always acquired from the database server 3 completely and necessarily, for example, the advertisement information can be also pre-stored in the HDD 201c of the advertisement display terminal 201. In addition, the advertisement information associated with the information read from the RF tag 9r is not always selected necessarily based on the corresponding table stored in the database server 3, and the advertisement information can also be selected by utilizing the corresponding table as shown in FIG. 6 which is stored in the HDD 201c of the advertisement display terminal 201 in advance.

Furthermore, the advertisement information herein, for example, can be listed as following:

(1) Providing commodity information which may be capable of arousing the purchase desire of the customer;

(2) Providing a recommended recipe using a purchased food material;

(3) Reminding a purchaser not to forget to buy something by notifying a commodity associated with the purchased commodity;

(4) Notifying information of scheduled sales to be carried out recently;

and the like, and the information can be selected by being associated with the information about the commodity purchased by the purchaser in the data table.

Thereby, when bagging the purchased commodity after the checkout on the commodity is just completed, the purchaser will see the advertisement information selected according to the commodity purchased just before, and thereby, a better advertisement effect can be achieved.

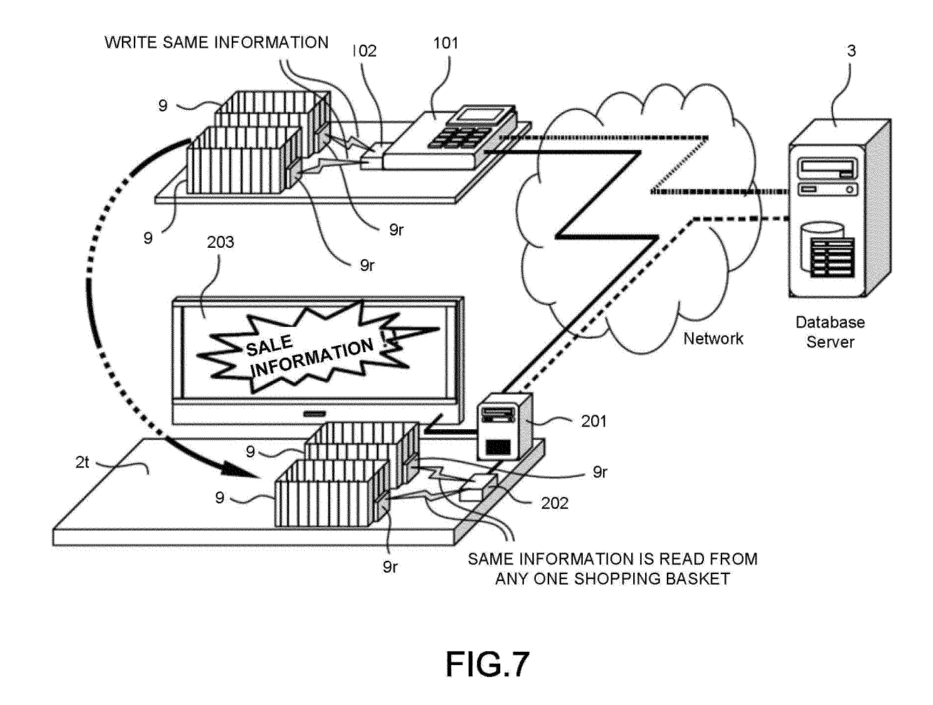

Furthermore, as shown in FIG. 7, in a case where the purchaser utilizes a plurality of shopping baskets 9 (namely, a case where a plurality of RF tags attached to the shopping baskets 9 serving as the objects subjected to the checkout by the purchaser exist), the writing control section 702 writes the same information in all the RF tags 9r attached to the plurality of shopping baskets 9 respectively through the writing apparatus 102.

In this way, no matter which one in the plurality of shopping baskets is put in a reading range of the reading apparatus 202 at the position of the taking-out place 2t by the purchaser, the suitable advertisement information for the purchaser selected according to the commodity purchased by the purchaser can be provided.

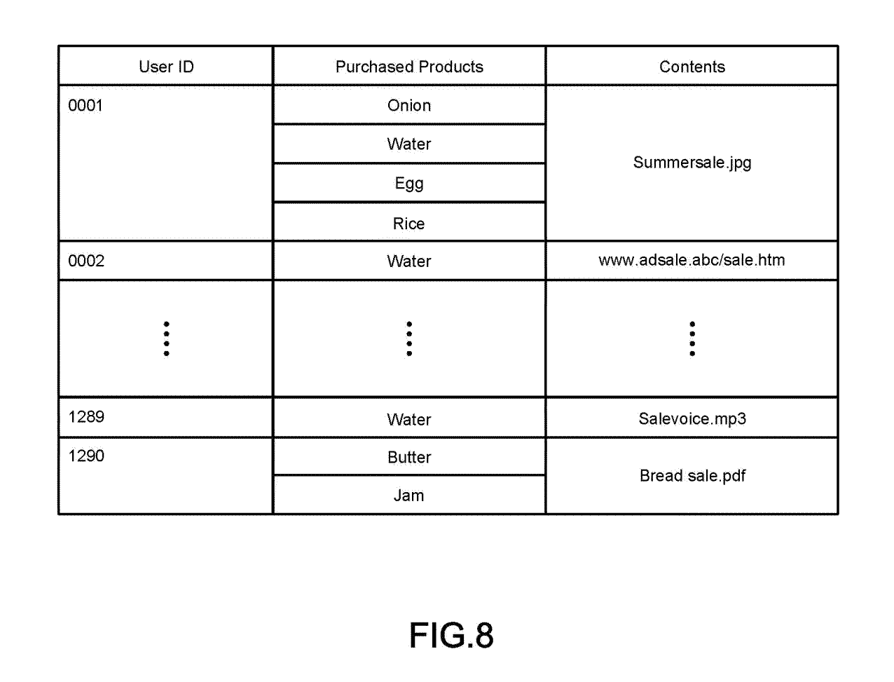

In addition, for example, as shown by a data table in FIG. 8, for example, in a case where the same commodities “Water” are purchased, it can also be set that the advertisement content is different according to different user.

Herein, as an example, it is exemplified that when a user of ID0002 purchases “Waster”, information of “www.adsale.abc/sale.htm” is displayed as the advertisement information on the screen of the display apparatus 203, and when a user of ID1289 purchases “Waster”, information of “Salesound.mp3tm” is notified in voice as the advertisement information through the speaker of the display apparatus 203. Such a change in content and a transfer method of the advertisement information according to users is effective in a case of intending to provide the advertisement in consideration of the past purchase history of the user and a case of intending to provide the suitable advertisement in consideration of a handicap and the like on the body of the user.

Furthermore, the CPU 201a (the notification control section 704) can also access the database and displays advertisement information for general customers stored in the database server 3 on the display apparatus 203 if the reading apparatus 202 cannot read the information required to select the advertisement information from the RF tag 9r, or if the writing apparatus 102 fails to write the information in the RF tag 9r, and the like. Furthermore, the advertisement information for general customers herein, for example, comprises advertisement information for a plurality of nonspecific customers unassociated with each user ID or the purchase result and the like of each user, such as the advertisement information associated with the current date or the advertisement information selected based on a past sales result.

Each operation in the processing in the advertisement support apparatus mentioned above and the advertisement support system comprising the advertisement support apparatus is realized by enabling a processor such as a CPU and the like to execute an advertisement support program stored in a memory. Of course, an acquirement source of a program executed by a CPU in each apparatus constituting the advertisement support system is not limited to a storage area of the apparatus provided with a CPU, for example, the program can be also downloaded from other apparatus via a network.

In addition, a program for enabling a computer constituting the advertisement support apparatus and the advertisement support system comprising the advertisement support apparatus to execute each operation mentioned above can also be provided as the advertisement support program. In the present embodiment, it is exemplified that the program for realizing the functions implementing the present invention is pre-recorded in a storage area arranged inside an apparatus, but it is not limited to this, same programs may be downloaded to the apparatus from a network. Alternatively, same programs may be stored in a recording medium readable by a computer, and then installed in the apparatus. The form of the recording medium is not limited as long as the recording medium can store programs and is readable by a computer. Specifically, as the recording medium, for example, an internal storage apparatus such as a ROM or a RAM and the like internally installed in a computer, a movable storage medium such as a CD-ROM or a flexible disk, a DVD, a magnetic optical disk, an IC card and the like, a database for storing a computer program, or other computer and the database thereof, a transmission medium on a line and the like can be listed. Further, the function realized by a pre-installed or pre-downloaded program can also be achieved through the cooperation with an OS (Operating System) installed in the apparatus.

Furthermore, one part or all of these programs can be also execution modules generated dynamically.

In addition, the various kinds of processing realized by enabling a processor to execute a program in the embodiments mentioned above can be partly or completely executed by an ASIC in a circuit manner.

As described in detail above, according to a technology described herein, a technology can be provided in which the advertisement content provided for the purchaser of the commodity is optimized, and moreover, the advertisement effect is improved.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An advertisement support apparatus, comprising:
a purchase associated information acquirement section configured to acquire information relating to a purchaser of a commodity or the commodity purchased by the purchaser;
a writing apparatus configured to write desired information in a RF tag attached to a shopping basket or a shopping card utilized by the purchaser when the commodity is purchased; and
a writing control section configured to write information relating to the information acquired by the purchase associated information acquirement section or advertisement information associated with the information in the RF tag attached to the shopping basket or the shopping card utilized by the purchaser when the commodity is purchased through the writing apparatus.

2. The advertisement support apparatus according to claim 1, wherein
the writing control section writes the information in the RF tag attached to the shopping basket or the shopping card utilized by the purchaser when the commodity is purchased through the writing apparatus after the purchaser completes checkout.

3. The advertisement support apparatus according to claim 1, wherein
if there exist a plurality of RF tags attached to the shopping baskets or the shopping cards serving as objects subjected to the checkout by the purchaser, the writing control section writes same information in all the RF tags attached to the plurality of shopping baskets or shopping cards respectively through the writing apparatus.

4. An advertisement support system, comprising:
a purchase associated information acquirement section configured to acquire information relating to a purchaser of a commodity or the commodity purchased by the purchaser;
a writing apparatus configured to write desired information in a RF tag attached to a shopping basket or a shopping card utilized by the purchaser when the commodity is purchased;
a writing control section configured to write information relating to the information acquired by the purchase associated information acquirement section or advertisement information associated with the information in the RF tag attached to the shopping basket or the shopping card utilized by the purchaser when the commodity is purchased through the writing apparatus;
a reading apparatus configured to be arranged at a taking-out place for the purchaser to take out the purchased commodity from the shopping basket or the shopping card, and configured to read the information in the RF tag attached to the shopping basket or the shopping card;
a notification apparatus configured to be arranged at a position which can be recognized by the purchaser at the taking-out place;
a reading control section configured to read the information from the RF tag attached to the shopping basket or the shopping card reaching the taking-out place through the reading apparatus when the shopping basket or the shopping card reaches the taking-out place; and
a notification control section configured to notify the advertisement information determined based on the information read by the reading apparatus to the purchaser at the taking-out place through the notification apparatus.

5. The advertisement support system according to claim 4, wherein
the writing control section writes the information in the RF tag attached to the shopping basket or the shopping card utilized by the purchaser when the commodity is purchased through the writing apparatus after the purchaser completes checkout.

6. The advertisement support system according to claim 4, wherein
if there exist a plurality of RF tags attached to the shopping baskets or the shopping cards serving as objects subjected to the checkout by the purchaser, the writing control section writes same information in all the RF tags attached to the plurality of shopping baskets or shopping cards respectively through the writing apparatus.

7. The advertisement support system according to claim 4, further comprising:
a database configured to store the information which is supposed to be written in the RF tag attached to the shopping basket or the shopping card in association with information for recognizing an advertisement content associated with the information or the advertisement content associated with the information, wherein
the notification control section notifies the advertisement information determined based on the information stored in the database associated with the information read by the reading apparatus to the purchaser at the taking-out place.

8. The advertisement support system according to claim 4, wherein
the notification apparatus is at least one of a display and a speaker.

9. An advertisement support method, comprising:
acquiring information relating to a purchaser of a commodity or the commodity purchased by the purchaser;
writing the information relating to acquired information or advertisement information associated with the information in a RF tag attached to a shopping basket or a shopping card utilized by the purchaser when the commodity is purchased through a writing apparatus;
reading the information from the RF tag attached to a shopping basket or a shopping card when the shopping basket or the shopping card reaches the taking-out place for taking out the purchased commodity from the shopping basket or the shopping card; and
notifying the advertisement information determined based on the information read from the RF tag to the purchaser at the taking-out place through a notification apparatus.

10. The advertisement support method according to claim 9, wherein
the information is written in the RF tag attached to the shopping basket or the shopping card utilized by the purchaser when the commodity is purchased through a writing apparatus after the purchaser completes checkout.

11. The advertisement support method according to claim 9, wherein
if there exist a plurality of RF tags attached to the shopping baskets or the shopping cards serving as objects subjected to the checkout by the purchaser, same information is written in all the RF tags attached to the plurality of shopping baskets or shopping cards respectively through the writing apparatus.

12. The advertisement support method according to claim 9, wherein
a database, in which the information supposed to be written in the RF tag attached to the shopping basket or the shopping card is stored in association with the information for recognizing an advertisement content associated with the information or the advertisement content associated with the information, is accessed, and the advertisement information determined based on the information associated with the information read by a reading apparatus and stored in the database is notified to the purchaser at the taking-out place.

13. The advertisement support method according to claim 9, wherein
the notification apparatus is at least one of a display and a speaker.
